(19) United States
(12) Patent Application Publication
(10) Pub. No.: US 2008/0047446 A1
(43) Pub. Date: Feb. 28, 2008

(54) Printing plate and corresponding printing assembly

(75) Inventors: Dominique Malkic, Verneuil en Halatte (FR); Dominique Deslangle, Meung sur Loire (FR)

Correspondence Address: DAVIDSON, DAVIDSON & KAPPEL, LLC, 485 SEVENTH AVENUE, 14TH FLOOR, NEW YORK, NY, 10018, US

(73) Assignee: GOSS INTERNATIONAL MONTATAIRE SA, Montataire (FR)

(21) Appl. No.: 11/894,937

(22) Filed: Aug. 22, 2007

(30) Foreign Application Priority Data
Aug. 22, 2006 (FR) 06 07456

(51) Int. Cl. B41F 5/00; B41F 13/08

(52) U.S. Cl. 101/216; 101/378

(57) ABSTRACT

This printing plate (6) for a rotary press includes a head (22) for fastening to an impression cylinder, and a tail (24) for fastening to the impression cylinder.

The fastening head (22) includes a holding projection (28) suitable for mating with an element (34) for holding the impression cylinder.

### TECHNICAL FIELD

The present invention relates to a printing plate for a rotary press, of the type comprising a head for fastening to an impression cylinder, and a tail for fastening to an impression cylinder.

The invention concerns in particular rotary presses which change plate automatically.

### BACKGROUND TO THE INVENTION

A printing plate suitable for being fitted on an impression cylinder is known from U.S. Pat. No. 6,601,509. The printing plate comprises a fastening head and a fastening tail suitable for being received in a fitting channel of the cylinder.

The fastening head of the plate comprises an opening in which a fastening leaf spring engages in order to hold the fastening head in the fitting channel.

The leaf spring mating with the opening is folded in two opposing directions in the shape of an S. The leaf spring engages with a ridge which is formed by its common portion and is bent into the opening.

The object of the present invention is to increase the forces holding the printing plate to the cylinder and to allow rotation of the impression cylinder at high speeds.

### SUMMARY OF THE INVENTION

To this end, the invention relates to a printing plate of the aforementioned type, wherein the fastening head comprises a holding projection suitable for mating with an element for holding the impression cylinder.

According to other embodiments, the printing plate according to the invention comprises one or more of the following characteristics:
the holding projection is made in one piece with the fastening head;
the holding projection comprises a boss provided in the printing plate; and
the fastening head delimits a free edge of the head, and the boss has a longitudinal shape which extends along the edge of the head of the printing plate.

In addition, the invention relates to a printing assembly for a rotary press, of the type comprising
an impression cylinder having a cylindrical outer surface and provided with a fitting channel which opens onto the outer surface,
a printing plate disposed on the impression cylinder, and
a holding device disposed in the fitting channel and suitable for holding the printing plate on the impression cylinder, wherein the printing plate is a printing plate as defined hereinbefore, and wherein the holding device comprises a holding member suitable for holding the printing plate by mating with the holding projection.

According to other embodiments, the printing assembly comprises one or more of the following characteristics:
the holding device comprises a holding element provided with a first leaf spring which supports the holding member and is suitable for contacting the holding projection in order to hold the fastening head of the printing plate;
the first leaf spring comprises a first free leaf end forming the holding member;
the holding element comprises a second leaf spring suitable for contacting the fastening tail of the printing plate, and the first and the second leaf springs are made in one piece;
the first and second leaf springs comprise arms which, in a non-urged state, are coplanar; and
the second leaf spring comprises a second free end and each of the first and second ends is bent in the same direction.

### BRIEF DESCRIPTION OF DRAWINGS

A clearer understanding of the invention will be facilitated by the following description, given purely by way of example and with reference to the appended drawings, in which:

FIG. 1 is a cross-section of a printing assembly provided with a printing plate according to the invention;

FIG. 2 is an enlarged view of detail II of FIG. 1; and

FIG. 3 is a perspective view of a holding element according to the invention.

### DESCRIPTION OF PREFERRED EMBODIMENTS

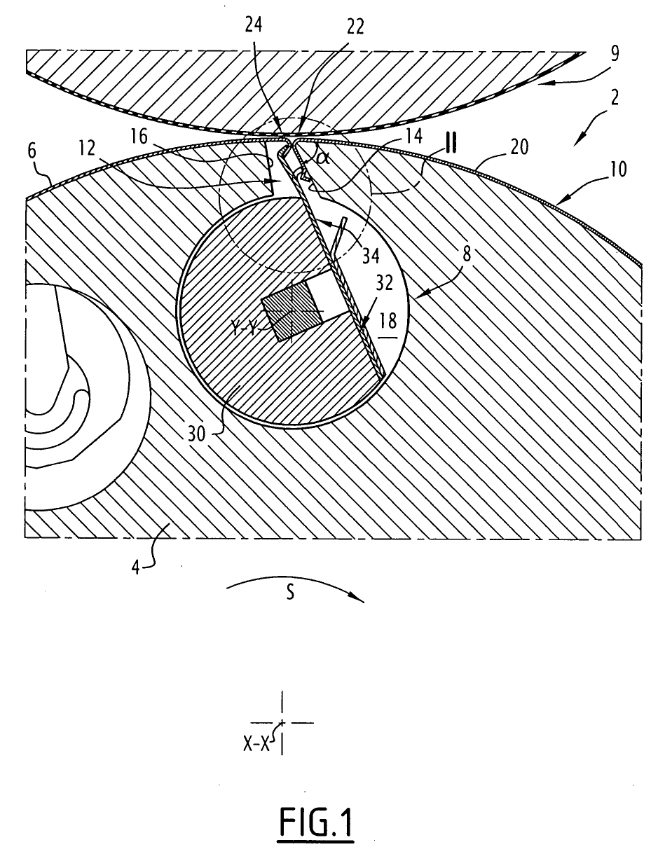

FIG. 1 is a cross-section of a portion of a printing assembly of a rotary press, designated with the general reference numeral 2.

The printing assembly 2 comprises an impression cylinder 4, also known as a plate cylinder, a printing plate 6 and a device 8 for holding the plate 6 on the impression cylinder 4. In addition, the printing assembly 2 comprises a blanket cylinder 9.

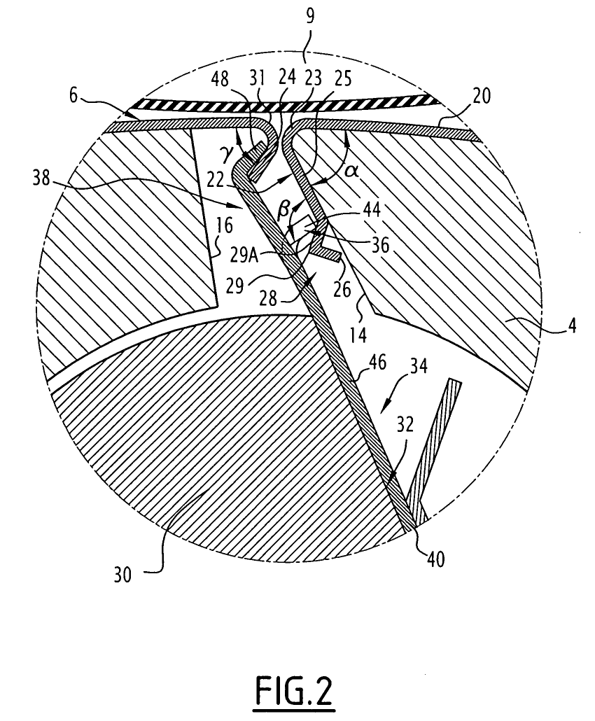

During operation, the impression cylinder 4 is driven in rotation about its centre axis X-X in a direction S which is the clockwise direction in FIGS. 1 and 2.

In the following, the terms “radially”, “axially” and “circumferentially” will be used in relation to the centre axis X-X.

The impression cylinder 4 defines a cylindrical outer surface with a circular cross-section 10. In addition, the impression cylinder 4 comprises a fitting channel 12 which opens onto the outer surface 10 and has a trapezoidal cross-section. The fitting channel 12 forms a front planar wall 14 and a rear planar wall 16 which extend facing one another. On the side remote from the outer surface 10, the fitting channel 12 widens to form a cylindrical recess with a circular cross-section 18.

The printing plate 6 is, for example, made of a thin metal sheet and comprises a common portion 20 which is provided with an image to be printed. At its ends the printing plate 6 has a fastening head 22 and a fastening tail 24.

The fastening head 22 has a flat central portion 25. Said central portion 25 is connected to the common portion 20 of the printing plate 6 by a bent portion 23 and forms an acute angle a with said common portion 20. The central portion 25 of the fastening head 22 rests flat against the front wall 14.

The fastening head 22 also delimits a free edge 26, which, when fitted, extends parallel to the centre axis X-X.

In addition, the fastening head 22 forms a holding projection 28. The holding projection 28 is connected on one side to the central portion 25 and to the free edge 26 on the other and thus forms a free end of the fastening head 22. In the present case, the holding projection 28 is made in one piece with the printing plate 6 and takes the form of a boss provided on said fastening head 22. The boss 28 has a longitudinal shape which extends along the edge of the head of the printing plate.

When shown in cross-section as in FIG. 2, the holding projection 28 is generally V-shaped. The tip 29 of the V points away from the front wall 14. In addition, the holding projection 28 comprises an inclined portion 29A which is defined by the radially exterior arm of the V and which is inclined by an obtuse angle β relative to the central portion 25 of the fastening head 22.

In a variation, the holding projection 28 may have a C-shaped or U-shaped cross-section.

The fastening tail 24 is formed by a bent portion 31 of the printing plate 6 which forms an acute angle γ with the common portion 20.

When fitted, the holding projection 28 is disposed radially internally relative to the fastening tail 24.

The holding device 8 comprises a clamping bar 30 disposed in the recess 18 so as to be displaceable about an axis of rotation Y-Y. The clamping bar 30 is provided with a flat portion 32 on which a holding element 34 is fixed. The holding element 34 is made in one piece of metal sheet, preferably spring steel.

The holding element 34 is provided with a first leaf spring 36 and a second leaf spring 38, the two leaf springs 36, 38 being connected by a base element 40.

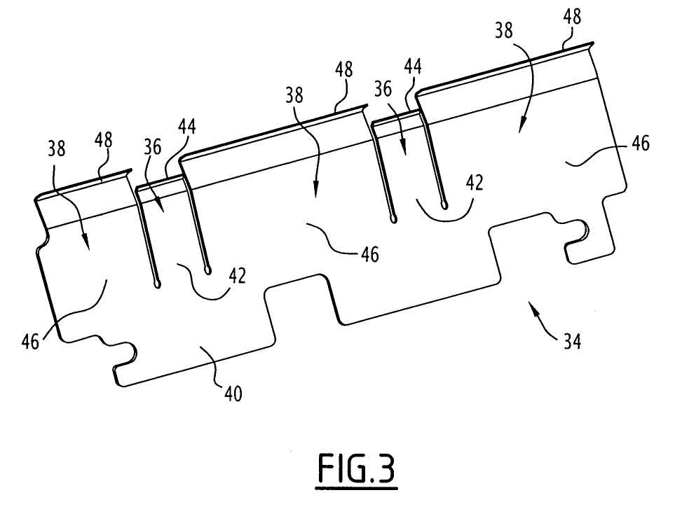

As shown in FIG. 3, a plurality of first leaf springs 36 and a plurality of second leaf springs 38 may be fixed to the base element 40. The example shown comprises two first leaf springs 36 and three second leaf springs 38.

The first leaf spring 36 consists of a first leaf arm 42 and a first free leaf end 44.

The second leaf spring 38 consists of a second leaf arm 46 and a second free leaf end 48.

The leaf arms 42, 46 are bent in the same direction, which simplifies the holding element 34 to be formed by folding.

The first leaf end 44 is radially set back in relation to the second free leaf end 46. Furthermore, the first free leaf end 44 is bent relative to the first leaf arm 42. The second free leaf end 48 is bent relative to the second leaf arm 46. The first 44 and second 48 free leaf ends are bent in the same direction relative to their associated leaf arm. As can be seen in FIG. 3, the leaf arms 46, 48 of the leaf springs 36, 38 are coplanar in the non-urged state of the holding element 24.

The first free end 44 is suitable for contacting the holding projection 28, specifically the inclined portion 30, in order to hold the fastening head 22 in the fitting channel 12.

By shape-mating, the first free leaf end 44 and the holding projection 28 prevent the fastening head 22 from being drawn out radially towards the exterior during operation of the printing press.

In addition, the wall thickness of the holding element 34 is identical over its entire area such that fewer deforming operations are required.

The printing assembly 2 according to the invention operates in the following manner.

Proceeding from the situation in which the printing plate 6 is disposed on the impression cylinder 4, and where the fastening head 22 and the fastening tail 24 extend into the holding channel 16. The holding element 34 is not in contact with the printing plate 6 and is in a tilted position in the anticlockwise direction in relation to that of FIG. 1 and 2.

In order to fix the printing plate 6 disposed on the impression cylinder 4, the clamping bar 30 is rotated in a locking direction, which is clockwise in FIG. 1 and 2. During this rotation, the free end 44 of the first leaf spring 36 comes into contact with the inclined portion 30 of the boss 28, and creates a reaction force which pulls the fastening head 22 radially towards the interior.

At the same time, the free end 48 of the second leaf spring 38 engages behind the fastening tail 24 by shape-mating and pulls the fastening tail 24 circumferentially towards the fastening head 22.

The contact between the first free end 44 and the inclined portion 30 allows the fastening head 22 to be held securely without play. Consequently, the impression cylinder 4 may be driven at very high rotational speeds reaching, for example, 60,000 revolutions per hour.

In addition, forming the holding projection 28 in one piece with the printing plate 6 ensures that manufacturing costs are kept low.

1: A printing plate for a rotary press comprising:
a fastening head for fastening to an impression cylinder, and
a fastening tail for fastening to the impression cylinder,
wherein the fastening head comprises a holding projection for mating with a holding element of the impression cylinder.

2: The printing plate recited in claim 1, wherein the holding projection is made in one piece with the fastening head.

3: The printing plate to recited in claim 2, wherein the holding projection comprises a boss provided in the printing plate.

4: The printing plate recited in claim 3, wherein the fastening head delimits a free edge of the fastening head, and wherein the boss has a longitudinal shape which extends along the free edge of the fastening head of the printing plate.

5: A printing assembly for a rotary press comprising:
an impression cylinder having a cylindrical outer surface and a fitting channel which opens onto the outer surface,
a printing plate disposed on the impression cylinder, and
a holding device disposed in the fitting channel suitable for holding the printing plate on the impression cylinder,
wherein the printing plate is a printing plate as recited in claim 1, and
wherein the holding device comprises a holding member suitable for holding the printing plate by mating with the holding projection.

6: A printing assembly recited in claim 5, wherein the holding device further comprises a holding element provided with a first leaf spring which supports the holding member and is suitable for contacting the holding projection in order to hold the fastening head of the printing plate.

7: A printing assembly recited in claim 6, wherein the first leaf spring comprises a first free leaf end forming the holding member.

8: A printing assembly recited in claim 6, wherein the holding element further comprises a second leaf spring suitable for contacting the fastening tail of the printing plate.

9: A printing assembly recited in claim 8, wherein the first leaf spring and the second leaf spring are made in one piece.

10: A printing assembly recited in claim 9, wherein the first leaf spring and the second leaf spring comprise arms which, in a non-urged state, are coplanar.

11: A printing assembly recited in claim 7, wherein the holding element further comprises a second leaf spring suitable for contacting the fastening tail of the printing plate,
wherein the second leaf spring comprises a second free leaf end, and
wherein the first free leaf end and the second free leaf end are bent in the same direction.
